(19) United States
(12) Patent Application Publication
(10) Pub. No.: US 2021/0252527 A1
(43) Pub. Date: Aug. 19, 2021

(54) AIR POWERED CENTRIFUGE

(71) Applicant: THE RESEARCH FOUNDATION FOR THE STATE UNIVERSITY OF NEW YORK, Albany, NY (US)

(72) Inventor: Ed LUK, Albany, NY (US)

(73) Assignee: THE RESEARCH FOUNDATION FOR THE STATE UNIVERSITY OF NEW YORK, Albany, NY (US)

(21) Appl. No.: 16/973,221

(22) PCT Filed: Jun. 7, 2019
(86) PCT No.: PCT/US19/35916

§ 371 Date: Dec. 8, 2020

Related U.S. Application Data
(60) Provisional application No. 62/682,459, filed on Jun. 8, 2018.

(51) Int. Cl. B04B 9/06; B04B 5/04; B04B 9/12; B29C 64/386; B33Y 50/00; B33Y 80/00

(52) U.S. Cl. CPC B04B 9/06; B04B 5/0414; B04B 9/12; B29L 2031/756; B33Y 50/00; B33Y 80/00; B29C 64/386

(57) ABSTRACT

The disclosure provides a microcentrifuge powered by pressurized gas. The microcentrifuge can be used to separate chemical and biological samples, including blood. The microcentrifuge can be made of plastic using 3D printing techniques.

### BACKGROUND OF THE DISCLOSURE

Microcentrifuges are used to spin small liquid samples, typically in tubes of about 1.5 to 2 ml in size, at high speeds to separate fluids or particles in suspension. Dimensionally, they are compact centrifuges having a small footprint suitable for use on a desk or bench top, or in settings where portability is important, such as, e.g., when microcentrifuges are transported by medical staff for use in remote regions or deployment in the field.

Current microcentrifuges are powered by electric motors. These suffer the following disadvantages: the electric motor increases the bulk and weight of the microcentrifuge, which in turn is detracts from its portability. Then, finding a suitable and reliable source of electricity to power the microcentrifuge in a remote region or when in the field is often problematic. Moreover, the speed at which the rotor spins is necessarily fixed by the size of the motor, which hampers use when higher speeds are needed.

There is thus a need for a microcentrifuge that is lightweight, easily transportable for use in remote areas, does not require electrical power, and can employ, when needed, spin speeds greater than those available by electric motor.

### SUMMARY OF THE DISCLOSURE

In one aspect, the disclosure relates to a microcentrifuge powered by pressurized gas, such as compressed air. The microcentrifuge comprises, in combination, at least the following component parts: a rotor-turbine fan comprising a topside, the topside comprising plurality of holders and a bottom side, the bottom side comprising a plurality of turbine vanes; a spindle on which the rotor-turbine fan is rotatably mounted, the spindle being attached to a base, which base also comprises a nozzle having an outlet proximate the turbine vanes and configured to impinge a pressurized gas, when passed through the nozzle, against the turbine vanes thereby rotating the rotor-turbine fan. The component parts are preferably each independently made of one or more plastics; one or more of the component parts can be created by 3D printing or from traditional molds. The microcentrifuge disclosed is of reduced overall weight, facilitating higher spin speeds and use in remote locations, and is cheaper and easier to produce than current microcentrifuges.

In another aspect, the disclosure provides a method of separating samples, such as chemical or biological samples, e.g., blood, wherein the sample comprises at least a first component and a second component, where the first component has a density different from the density of the second component. The sample is spun in a microcentrifuge of the disclosure by passing a pressurized gas through the nozzle to exit the nozzle outlet and impinge against the turbine vanes to rotate the rotor-turbine fan causing the separation of the first component from the second component.

In another aspect, the disclosure provides a method of making the component parts for a microcentrifuge of the disclosure, and the microcentrifuge itself, comprising obtaining three-dimensional (3D) model information data for one or more of the component parts, which component parts can then be 3D printed and assembled into a microcentrifuge. In still another aspect, the 3D printed component parts can be used to make molds suitable for plastic processing, e.g. molds of the 3D printed component parts can be stamped out and then used for injection molding to fabricate the component parts which are then assembled into a microcentrifuge. In another aspect, molds of the component parts can be designed and built as conventionally known.

### BRIEF DESCRIPTION OF THE DRAWINGS

FIG. 1 is side view of an embodiment of a microcentrifuge of the disclosure.

FIG. 2 is a top view of the embodiment of FIG. 1.

FIG. 3 is a perspective view of the embodiment of FIG. 1.

FIGS. 4A and 4B are, respectively, a top view and a side view, of an embodiment of a radial ball bearing useful in the microcentrifuge of FIG. 1.

FIG. 5 is an exploded cross sectional view of the embodiment of FIG. 1.

### DETAILED DESCRIPTION OF THE DISCLOSURE

The description herein is made with reference to the Figures for purposes of convenience only; it is exemplary and not restrictive of the disclosure.

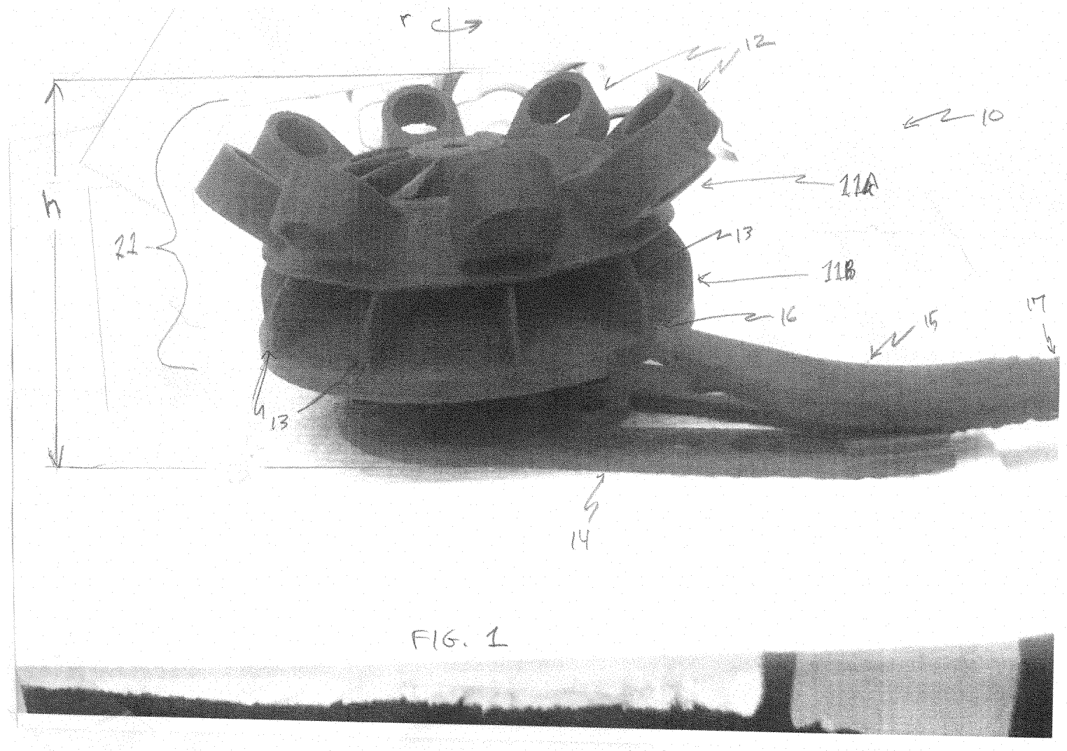

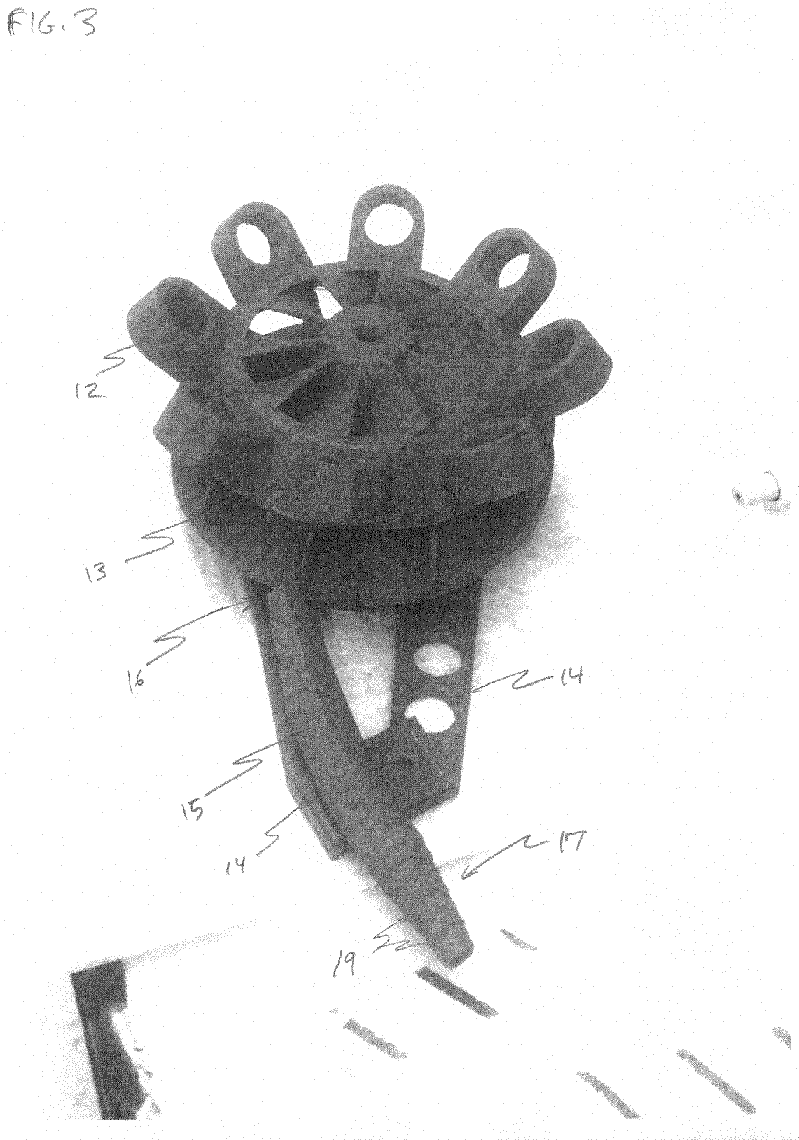

Referring to FIGS. 1, 2, and 3 in detail, thereat is a side view of an embodiment of a microcentrifuge 10 of the disclosure. The microcentrifuge comprises a rotor-turbine fan 11 which is comprised of at least a topside 11A and a bottom side 11B. Topside 11A has thereon a plurality of holders 12 which are configured to hold sample containers, such as centrifugal tubes, well plates or other containers. In one practice, the plurality of holders 12, as shown in FIG. 1, is configured to receive centrifugal tubes and is configured to extend the closed end of each of the centrifugal tubes outwardly from the rotational axis, “r,” of the rotor-turbine fan, with the open end of each of the centrifugal tubes facing towards the rotational axis of the rotor-turbine fan. As shown in FIGS. 1, 2, and 3, the plurality of holders 12 comprises a plurality of discrete loops extending outwardly from topside 11A; in another embodiment (not shown) the plurality of holders 12 comprises a continuous ring extending outwardly from topside 11A, the continuous ring comprising a plurality of holes extending therethrough in which holes the sample containers, e.g. centrifugal tubes, can be held; this continuous ring configuration decreases drag during operation which facilitates higher speeds when needed. Bottom side 11B has thereon a plurality of turbine vanes 13 which can be integrally formed with the bottom side and which extend generally outwardly from and substantially uniformly around the rotational. The number of vanes can vary and include, without limitation, up to ten, up to twelve, or more. Rotor-turbine fan 11 is rotatably mounted on a spindle (not shown in FIG. 1). The spindle is attached to a base 14 that comprises a nozzle 15, the nozzle having a nozzle outlet 16, and a gas connector portion 17. Base 14 can comprise one or more holes for securing it to a platform or other surface for improved stability during operation. The gas connector portion 17 is sized and adapted to establish fluid communication, e.g. by compression fitting, between the nozzle 15 and to a pressurized gas source, including without limitation, a gas canister, gas tank, wall dispenser, and the like sources, see e.g. ribs 19 for compression fit on connector portion 17, FIG. 3. Pressurized gas can include, without limitation, compressed air. In another practice, the pressurized gas source is a pump, including without limitation, a manually operated pump, such as a foot pump, e.g. as commercially available for inflating tires, sports balls and the like. Operation of the foot pump provides the pressurized gas for rotation. The nozzle outlet 16 is located proximate the turbine vanes 13 such that pressurized gas exiting the nozzle outlet 16 impinges on the turbine vanes 13 to spin the rotor-turbine fan. In one practice (not shown), a shield, e.g. one or more curved shields, is provided which is configured optionally in conjunction with bottom side 11B and/or nozzle 15 and/or base 14 such that the compressed gas is directed to the turbine vanes 13, thus increasing efficiency.

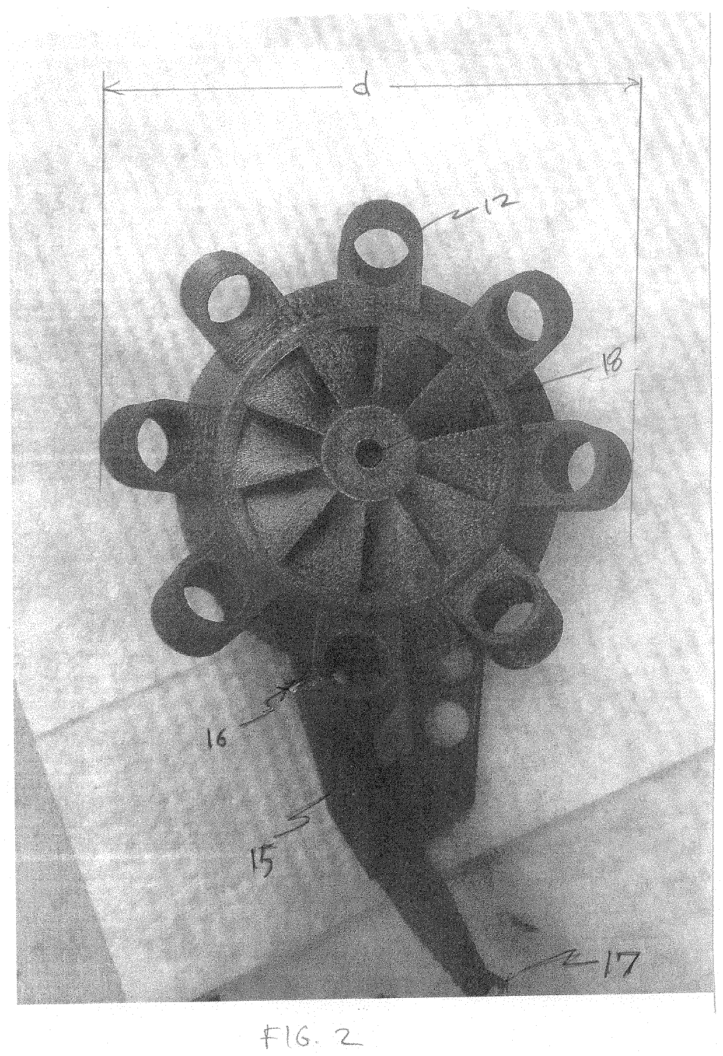

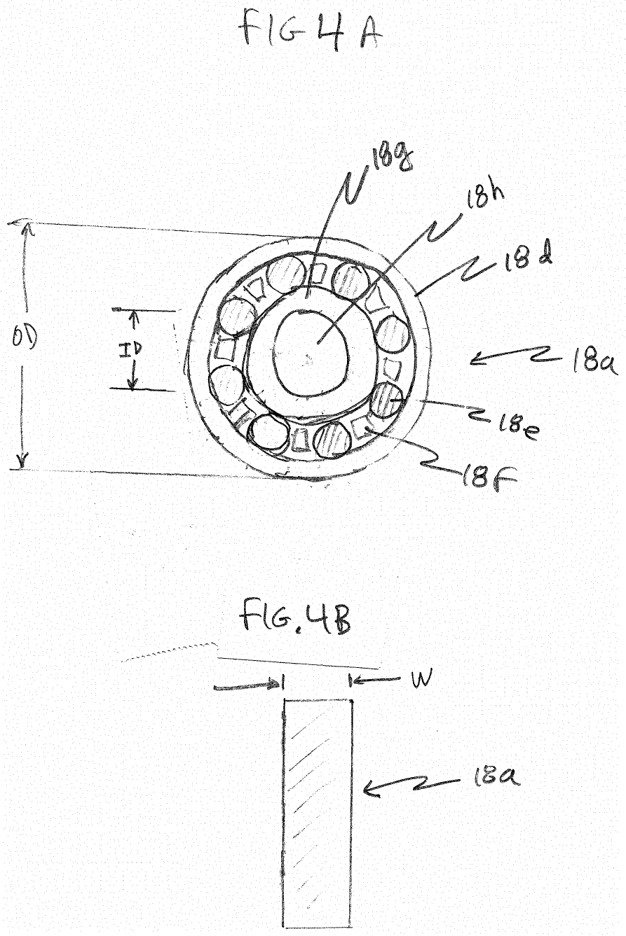

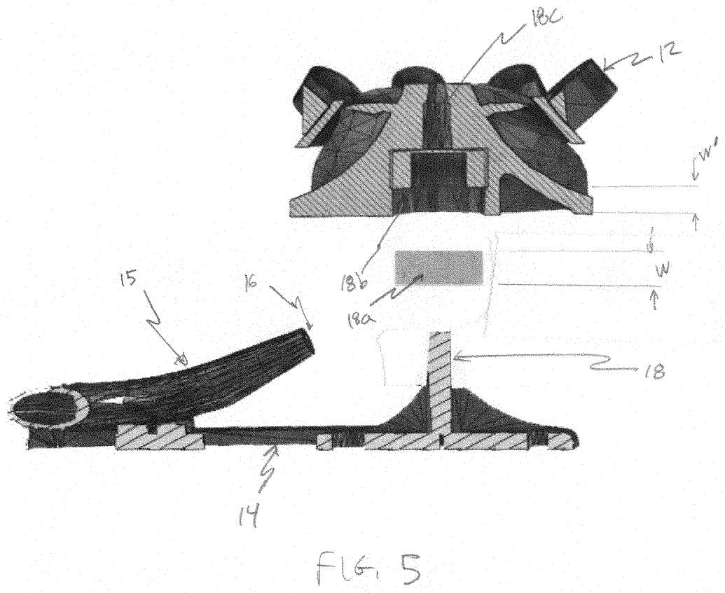

In one practice, the topside 11A and the bottom side 11B of rotor-turbine fan 11 are formed as a unitary body. In another practice, the topside 11A and bottom side 11B are each formed as separate pieces that are joined together by means known in the art, e.g. without limitation, by glue, solvent welding, pressure fit, snap fit, and the like, to form the rotor-turbine fan 11. Similarly, the base 14 comprising the nozzle 15 can be formed as a unitary body, or alternatively, can each be formed as separate pieces joined together by means known in the art as above. In one practice, the rotor turbine fan is rotatably mounted on the spindle. The spindle, the circular cross-sectional end of which is 18 as shown in FIG. 2, is of generally cylindrical shape, comprises bearings as known in the art, such as axial or radial ball bearings, including those conventionally available for use in skateboards, inline skates, and the like. In one practice, the bearings are attached to the spindle. The bearings can be of various shapes, e.g. ball, cylinder, barrel, needle, tapered and the like. Without limitation, serviceable ball bearings can be single row or double row, shielded or sealed on one or both sides to keep lubricant (if any) in and contaminants out, made of various materials of construction including plastic (e.g. nylon), ceramic, metal (e.g. steel), combinations of the foregoing. For example, suitable radial ball bearings include those commercially available and designated as 600 series, including the 608 series. FIGS. 4A and 4B depict top and side views of an embodiment of a ball bearing 18a, such as a 608 series ball bearing, useful in the microcentrifuge. Depicted are steel balls 18e interposed between outer ring 18d and inner ring 18g, steel balls 18e are separated by ball retainer 18f; inner ring 18g has hole 18h through which spindle 18 extends. Inner ring 18g has an inner diameter, ID, and outer ring 18d has an outer diameter, OD; ball bearing 18a has a width, W. The 608 series of ball bearing has an ID of about 8 mm, an OD of about 22 mm and a width, W, about 7 mm. FIG. 5 shows an exploded view of the microcentrifuge of FIG. 1, including specifically spindle 18 and radial bearing 18a. Without limitation, in one practice, assembly includes press fitting ball bearing 18a into depression 18b formed in the bottom of rotor turbine fan 11; in one practice, depression 18b is formed in bottom side 11B; in one practice, depression 18b is substantially the same size and shape as ball bearing 18a, and dimensioned to provide a compression (press) fit with ball bearing 18a. Spindle 18 is then press fitted into ball bearing 18a; spindle 18 can extend into opening 18c. In another practice (not shown), depression 18b extends to a depth such that ball bearing 18 when inserted, e.g. press fit, is proximate to or at the center of the bottom of rotor turbine fan 11; this configuration provides improved balance during operation and can necessitate a longer spindle 18 to accommodate the increased depth. In one practice (not shown), a clamp containing a second spindle for pressing onto ball bearing 18a and preventing the rotor turbine fan 11 from disengaging during operation is provided

In one practice, the microcentrifuge further comprises a housing, such as a lid, that encloses at least the rotor-turbine fan, including a housing that encloses the entire microcentrifuge assembly with vent means to allow escape of the pressurized gas. In another practice (not shown) one or more safety shields extending around and/or sufficiently above the centrifuge can be provided to protect the user. As seen in FIG. 1, the height, “h,” of the microcentrifuge, as measured from the bottom of the base 14 to the top of the rotor-turbine fan 11 is about 10 cm or less; about 8 cm or less; about 6 cm or less. In one practice as seen in FIG. 2, the diameter, “d,” of the microcentrifuge, as measured as the widest distance across the rotor-turbine fan 11 is about 15 cm or less; about 12 cm or less; about 10 cm or less. In one practice, the length of the nozzle 15 is about 12 cm or less; about 10 cm or less; about 8 cm or less. In one practice, the weight of the microcentrifuge 10, including the rotor-turbine fan 11, the base 14 comprising nozzle 15 and the spindle 18 is about 120 gms or less; about 100 gms or less; about 90 gms or less. In one practice, the rotor-turbine fan of the microcentrifuge spins at about 5000 rpm or greater; about 7000 rpm or greater; about 10,000 rpm or greater. The rpms can be varied by pressure of the gas, design of the nozzle, valving, and other conventional means.

In one practice, one or more, and preferably each of the rotor-turbine fan 11, base 14, nozzle 15 and spindle 18 are each independently comprised of a plastic. Serviceable plastics include thermoplastics, such as without limitation, acrylonitrile butadiene styrene (ABS), polycarbonate (PC), polylactic acid (PLA), high density polyethylene (HDPE), polyphenylsulfone (PPSU), poly(meth)acrylate, polyetherimide (PEI), polyether ether ketone (PEEK), high impact polystyrene (HIPS), polyethylene terephthalate (PET), thermoplastic polyurethane (TPU), polyamides (nylon) and combinations thereof.

In another embodiment, the disclosure provides a method of separating components in a sample. In one practice, the method comprises providing a microcentrifuge of the disclosure wherein the sample containers, e.g. centrifugal test tubes, typically about 1.5 to about 2 ml in size, or well plates, contain a sample comprising a first component and a second component wherein the first component has a density different from the density of the second component. The first component and the second component can each be a liquid, or the first component can be a solid (which term includes solid-like material) and the second component can be a liquid. The sample can be a chemical or biological sample. For example, the sample can be blood wherein the first component comprises corpuscular material and the second component comprises serum. The method comprises passing a pressurized gas through the nozzle to exit the outlet and impinge against the turbine vanes to rotate the rotor-turbine fan causing the separation in the sample holder of the first component from the second component.

In another embodiment, a method of making components for a microcentrifuge of the disclosure is provided. In one practice, three-dimensional (3D) model information data is obtained for one or more of the following components: (i) a topside of a rotor-turbine fan, the topside comprising a plurality of holders, (ii) a bottom side of the rotor-turbine fan, the bottom side comprising a plurality of turbine vanes, (iii) a spindle, (iv) a base component, and (v) a nozzle, the nozzle having an outlet. The 3D model information can be obtained by means known in the art, e.g., by 3D scanning of pre-existing models for any or all of components (i) to (v); or by computer-aided design (CAD) wherein models for any or all of components (i) to (v) are created virtually; or by obtaining the 3D model information for any or all of components (i) to (v) from a pre-existing virtual database, e.g. as downloaded from an online service. The 3D information is then provided to a 3D printer as known in the art whereafter any or all of components are 3D printed in a plastic suitable for 3D printing, e.g. a thermoplastic as defined, without limitation, above.

The topside and the bottom side of the rotor-turbine fan can be 3D printed as a unitary body, or alternatively, the topside and bottom side can be 3D printed as separate pieces that can be subsequently joined together. Similarly, the base and nozzle can be 3D printed as a unitary body, or alternatively, the base and nozzle can be 3D printed as separate pieces that can be subsequently joined together. A microcentrifuge of the disclosure can be made by providing bearings to the 3D printed spindle, and assembling the 3D printed topside and 3D printed bottom side of the rotor-turbine fan, the 3D printed spindle with bearings, and the 3D printed base with the 3D printed nozzle, having the nozzle outlet proximate the turbine vanes.

In another practice, any or all of the 3D printed components (i) to (v) can be used to create molds, which molds can then be used for the production of component parts. For example, the 3D printed topside and bottom side components can be stamped out into injection molds or other like molds as known in the art, from which a second topside and second bottom side, a second spindle, and a second base component comprising a second nozzle, all of which are essentially replicas of the 3D printed topside, bottom side, spindle and base with nozzle, can be made from thermoplastic, including economically in large quantities. A microcentrifuge of the disclosure can be made by providing bearings to second spindle, and assembling the second topside, second bottom side of the rotor fan, the second spindle with bearings, and the second base component having the nozzle outlet proximate the turbine vanes.

1. A microcentrifuge powered by pressurized gas comprising:
a rotor-turbine fan having a topside and a bottomside, the topside comprising a plurality of holders, and the bottom side comprising a plurality of turbine vanes; and
a spindle on which the rotor-turbine fan is rotatably mounted, the spindle attached to a base that comprises a nozzle, the nozzle having an outlet proximate the turbine vanes and configured to impinge a pressurized gas against the turbine vanes thereby rotating the rotor-turbine fan.

2. The microcentrifuge of claim 1 wherein the plurality of holders is configured to receive centrifugal tubes and configured to extend the closed end of each of the centrifugal tubes outwardly from the rotational axis of the rotor-turbine fan, with the open end of each of the centrifugal tubes facing towards the rotational axis of the rotor-turbine fan.

3. The microcentrifuge of claim 1 wherein (i) the topside and the bottom side are formed as a unitary body, or (ii) the topside and the bottom side are each formed as separate pieces joined together to form the rotor-turbine fan.

4. The microcentrifuge of claim 3 (ii) wherein the separate pieces are joined by glue, solvent welding, snap fit, pressure fit or combinations thereof.

5. The microcentrifuge of claim 1 wherein the spindle comprises a radial ball bearing.

6. The microcentrifuge of claim 1 further comprising a pressurized gas source in fluid communication with the nozzle.

7. The microcentrifuge of claim 1 further comprising a housing enclosing at least the rotor-turbine fan.

8. The microcentrifuge of claim 1 wherein one or more of the rotor-turbine fan, the base, and the nozzle are each comprised of a plastic.

9. The microcentrifuge of claim 1 wherein the height of the microcentrifuge is about 10 cm or less, and the diameter of the rotor-fan turbine is about 15 cm or less.

10. A method of separation comprising:
(a) providing a microcentrifuge comprising:
(i) a rotor-turbine fan having a topside and a bottom side, the topside comprising a holder having a sample container containing a sample, the sample comprising a first component and a second component, the first component having a density different from the density of the second component, the bottom side comprising a plurality of turbine vanes; and
(ii) a spindle on which the rotor-turbine fan is rotatably mounted, the spindle attached to a base that comprises a nozzle, the nozzle having an outlet proximate the turbine vanes
(b) passing a pressurized gas through the nozzle to exit the outlet and impinge against the turbine vanes to rotate the rotor-turbine fan thereby separating, in the sample container, the first component from the second component.

11. The method of claim 10 wherein the sample is a chemical or a biological sample.

12. The method of claim 11 wherein the first component and the second component are both liquids, or the first component is a solid and the second component is a liquid.

13. The method of claim 11 wherein the sample is blood and the first component comprises corpuscular material and the second component comprises serum.

14. The method of claim 11 wherein the sample container is a centrifugal tube or a well plate.

15. The method of claim 14 wherein the centrifugal tube is about 1.5 to about 2 ml in size.

16. A method of making components for a microcentrifuge comprising:
(a) obtaining three-dimensional (3D) model information data for (i) a topside of a rotor-turbine fan the topside having a plurality of sample holders, (ii) a bottom side of the rotor-turbine fan, the bottom side having a plurality of turbine vanes, (iii) a spindle, (iv) a base, and (v) a nozzle, the nozzle having an outlet;
(b) providing the 3D model information to a 3D printer; and
(c) 3D printing, in a plastic, the topside and the bottom side of the rotor turbine fan, the spindle, the base, and the nozzle, wherein the topside and the bottom side are 3D printed as a unitary body or as separate pieces, and wherein the base and the nozzle are 3D printed as a unitary body or as separate pieces.

17. The method of claim 16 wherein in step (a) the 3D model information is obtained by:
(1) 3D scanning of a pre-existing model of one or more of (i), (ii), (iii), (iv) or (v), or
(2) computer-aided design (CAD) of one or more of (i), (ii), (iii), (iv) or (v).

18. The method of claim 16 further comprising:
(d) making molds of the 3D printed topside and bottom side of the rotor fan, the 3D printed spindle, and the 3D printed base, and the 3D printed nozzle; and
(e) making in a plastic, from the molds, a second topside and second bottom side of a second rotor-turbine fan, a second spindle, a second base component, and a second nozzle.

19. A method of making a microcentrifuge comprising:
providing bearings to the 3D printed spindle of claim 16; and
assembling the 3D printed topside and bottom side of the rotor fan of claim 16, the 3D printed spindle comprising the bearings, the 3D printed base, and the 3D printed nozzle of claim 16 to form a microcentrifuge having the nozzle outlet proximate the turbine vanes.

20. A method of making a microcentrifuge comprising:
providing bearings to the second spindle of claim 18; and
assembling the second topside and second bottom side of the second rotor-turbine fan of claim 18, the second spindle comprising the bearings, the second base, and the second nozzle of claim 18 to form a microcentrifuge having the nozzle outlet proximate the turbine vanes.
